(19) United States
(12) Patent Application Publication
(10) Pub. No.: US 2019/0215148 A1
(43) Pub. Date: Jul. 11, 2019

(54) METHOD OF ESTABLISHING ANTI-ATTACK PUBLIC KEY CRYPTOGRAM

(71) Applicant: SHENZHEN UNIVERSITY, Shenzhen (CN)

(72) Inventors: Weijian Wang, Shenzhen (CN); Xiaofeng Wang, Shenzhen (CN); Li Xu, Shenzhen (CN); Liyuan Wang, Shenzhen (CN)

(21) Appl. No.: 15/869,004

(22) Filed: Jan. 11, 2018

(51) Int. Cl. H04L 9/00; H04L 9/30

(52) U.S. Cl. CPC H04L 9/002; H04L 9/3013

(57) ABSTRACT

A method of establishing an anti-attack public key cryptogram includes (1) two parties select a braid group Bₙ with n≥7, and Bₙ= [symbol] σ₁, σ₂, . . . , σₙ₋₁| σᵢσⱼ=σⱼσᵢ, |i−j|≥2, σᵢσᵢ₊₁σᵢ=σᵢ₊₁σᵢσᵢ₊₁, 1≤i≤n−2 [symbol] , (2) the two parties select two subgroups A and B in Bₙ generated from a₁, a₂, . . . , aₖ and b₁, b₂, . . . , bₘ respectively, (3) the first party selects an element x=x (a₁, a₂, . . . , aₖ)∈A as a first private key, and sends x⁻¹b₁x, x⁻¹b₂x, . . . , x⁻¹bₘx to the second party, (4) the second party selects an element y=y (b₁, b₂, . . . , bₘ)∈B as a second private key, and sends y⁻¹a₁y, y⁻¹a₂y, . . . , y⁻¹aₖy to the first party, (5) the first party obtains K_{A}=x⁻¹x(y⁻¹a₁y, y⁻¹a₂y, . . . , y⁻¹aₖy)=x⁻¹y⁻¹xy, (6) the second party obtains y⁻¹y(x⁻¹b₁x, x⁻¹b₂x, . . . , x⁻¹bₖx)=y⁻¹x⁻¹yx, and calculates to obtain K_{B}=(y⁻¹x⁻¹yx)⁻¹=x⁻¹y⁻¹xy, thereby reaching a shared secret key K=K_{A}=K_{B}.

### TECHNICAL FIELD

The present disclosure relates to the field of information security, and in particular to a method of establishing an anti-attack public key cryptogram.

### BACKGROUND

Symmetric cryptography, such as AES, has proven to be a very efficient and secure method of transmitting confidential information. However, due to the use of a symmetric secret key for encryption and decryption, both parties during a confidential information transmission must establish a shared secret key through a secret key exchange protocol.

In a classic secret key sharing algorithm, as a practical calculation and security issue, its difficulty will be greatly reduced with the improvement of computer performance. In particular, Shor proposed the famous Shor quantum algorithm in 1997. The factorization of integers and the calculation of discrete logarithms will be performed respectively in polynomial time. This means that once quantum computer is achieved, the secret key sharing protocol established based on RSA, ECC, ElGamal algorithm, and the like will no longer be safe.

In Chinese patent number ZL201310382299.7, the structure of Mihailova subgroups of a braid group with exponent n is disclosed. The membership problem of the subgroup is unsolvable. This serves as a core element in establishing a new and highly secure cryptosystem.

### SUMMARY

In order to solve the potential security problem based on the existing secret key sharing protocol, an object of the present disclosure is to establish a public key cryptographic method against various attacks by the innovative introduction of unsolvability of a subgroup membership problem in a Mihailova subgroup of a braid group, and the conjugation property of the elements of the group.

The object of the present disclosure can be achieved by a method of establishing an anti-attack public key cryptogram, including the following steps:
(1) two parties of a protocol select a braid group Bₙ with exponent n≥7, and the braid group Bₙ is defined by the following presentation:

Bₙ= [symbol] σ₁, σ₂, . . . , σₙ₋₁| σᵢσⱼ=σⱼσᵢ, |i−j|≥2, σᵢσᵢ₊₁σᵢ=σᵢ₊1σᵢσᵢ₊₁, 1≤i≤n−2 [symbol] ,
each element of the braid group Bₙ being denoted by a word on a set {σ₁, σ₂, . . . , σₙ₋₁} that represents the element, possesses uniqueness and takes a normal form;
(2) the two parties of the protocol select two sets of elements in Bₙ, a₁, a₂, . . . , aₖ and b₁, b₂, . . . , bₘ, to generate two subgroups A and B of Bₙ respectively;
(3) a first party of the two parties selects an element x=x(a₁, a₂, . . . , aₖ )∈A as a first private key, and sends x⁻¹b₁x, x⁻¹b₂x, . . . , x⁻¹bₘx to a second party of the two parties;
(4) the second party selects an element y=y(b₁, b₂, . . . , bₘ)∈B as a second private key, and sends y⁻¹a₁y, y⁻¹a₂y, . . . , y⁻¹aₖy to the first party;
(5) after the first party receives the elements sent by the second party, the first party replaces all aᵢ in x with y⁻¹aᵢy (i=1, 2, . . . , k) to obtain

K_{A}=x⁻¹x(y⁻¹a₁y, y⁻¹a₂y, . . . , y⁻¹aₖy)=x⁻¹y⁻¹xy;
(6) after the second party receives the elements sent by the first party, the second party replaces all bⱼ in y with x⁻¹bⱼx (j=1, 2, . . . , m) to obtain

y⁻¹y(x⁻¹b₁x, x⁻¹b₂x, . . . , x⁻¹bₖx)=y⁻¹x⁻¹yx,
and calculates to obtain

K_{B}=(y⁻¹x⁻¹yx)⁻¹=x⁻¹y⁻¹xy;
since K_{A}=K_{B}, the first party of the protocol and the second party of the protocol reach a shared secret key K=K_{A}=K_{B}.

In a preferred embodiment, the braid group Bₙ is a Mihailova subgroup having an unsolvable subgroup membership, and both the subgroups A and B are Mihailova subgroups.

In a preferred embodiment, the braid group Bₙ is a group defined by the following presentation:

Bₙ= [symbol] σ₁, σ₂, . . . , σₙ₋₁| σᵢσⱼ=σⱼσᵢ, |i−j|≥2, σᵢσᵢ₊₁σᵢ=σᵢ₊₁σᵢσᵢ₊₁, 1≤i≤n−2 [symbol] ,

each element of the braid group Bₙ is denoted by a word on a set {σ₁, σ₂, . . . , σₙ₋₁} that represents the element, possesses uniqueness and takes a normal form;

when n≥7, Bₙ contains two subgroups isomorphic to F₂×F₂, i.e., two subgroups isomorphic to the direct product of two free groups with a rank of 2:

P= [symbol] σ₁², σ₂², σ₄², σ₅²

[symbol]

and

[symbol]

= [symbol] σ₂², σ₃², σ₅², σ₆² [symbol] ;

then use a presentation that has a finite presentation group whose word problem is unsolvable and is generated by two elements so that subgroup A of P is a Mihailova subgroup, and subgroup B of Q is a Mihailova subgroup;

56 generators of A are shown below, wherein i=1, and the 56 generators of A are obtained; and if i=2, 56 generators of B are obtained:

σᵢ²σᵢ₊₃², σᵢ₊₁²σᵢ₊₄², Sᵢⱼ, Tᵢⱼ, j=1, 2, . . . , 27

while 27 Sᵢⱼ are:
Sᵢ₁: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₂: (σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²
Sᵢ₃: (σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²
Sᵢ₄: (σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁶)⁻¹ σᵢ₊₁⁻⁶σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²
Sᵢ₅: (σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁴)⁻¹ σᵢ₊₁⁻⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²
Sᵢ₆: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁴)¹ σᵢ₊₁⁻¹⁴σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₇: (σᵢ²σᵢ₊₁⁴σᵢ⁻²σᵢ₊₁⁴σᵢ⁴σᵢ₊₁⁻⁴σᵢ⁻²σᵢ₊₁⁻²σᵢ²σᵢ₊₁⁴(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁶σᵢ⁴σᵢ₊₁⁻¹⁰σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₈: (σᵢ²σᵢ₊₁⁶σᵢ⁻²σᵢ₊₁⁶σᵢ⁴σᵢ₊₁⁻⁶σᵢ⁻²σᵢ₊₁⁻²σᵢ²σᵢ₊₁⁶(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₉: (σᵢ²σᵢ₊₁⁸σᵢ⁻²σᵢ₊₁⁸σᵢ⁴σᵢ₊₁⁻⁸σᵢ⁻²σᵢ₊₁⁻²σᵢ²σᵢ₊₁²(σᵢ⁻⁴σᵢ₊₁⁻¹⁰σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,10}: (σᵢ²σᵢ₊₁¹⁰σᵢ⁻²σᵢ₊₁¹⁰σᵢ⁴σᵢ₊₁⁻¹⁰σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁⁶)⁻¹ σᵢ₊₁⁻⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,11}: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁶)⁻¹ σᵢ₊₁⁻¹⁶σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,12}: (σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁴)⁻¹ σᵢ₊₁⁻¹⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²
S_{i,13}: (σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²
S_{i,14}: (σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²
S_{i,15}: (σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²
S_{i,16}: (σᵢ₊₁⁻⁶σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻²⁰σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁⁶
S_{i,17}: (σᵢ₊₁⁻⁴σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²⁰σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁⁴
S_{i,18}: (σᵢ⁻⁴σᵢ₊₁⁻¹²σᵢ²σᵢ₊₁²σᵢ⁻²σᵢ₊₁¹²σᵢ⁴σᵢ₊₁⁻¹²σᵢ⁻²σᵢ₊₁⁻²σᵢ²σᵢ₊₁¹⁰σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁²σᵢ⁴ σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁²σᵢ⁴σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁⁻¹⁸σᵢ² σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁)²)² σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²)⁻¹ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)⁻²σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁⁻¹⁸σᵢ² σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ σᵢ⁻⁴σᵢ₊₁⁻¹²σᵢ²σᵢ₊₁²σᵢ⁻²σᵢ₊₁¹²σᵢ⁴σᵢ₊₁⁻¹²σᵢ⁻²σᵢ₊₁⁻²σᵢ²σᵢ₊₁¹⁰
S_{i,19}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶ σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,20}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)² σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)²σᵢ⁻⁴σᵢ₊₁¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,21}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)³ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)²σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)² σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)³σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,22}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁴ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)³σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)³ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁴σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,23}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁵ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁴ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁴ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁵σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,24}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁶ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁵ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁵ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁶σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,25}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁷ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁸σᵢ²σᵢ₊₁²94 ᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁶ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁷σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,26}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁸ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁷ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁷ σᵢ⁻⁴σᵢ₊₁⁻⁶σᵢ²σᵢ₊₁²σᵢ⁻²σᵢ₊₁⁶σᵢ⁴σᵢ₊₁⁻⁶94 ᵢ⁻²σᵢ₊₁⁻²σᵢ²σᵢ₊₁⁶(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁸σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,27}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁸ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁸ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
   when all σᵢ in each Sᵢⱼ are replaced by σᵢ₊₃ and all σᵢ₊₁in each Sᵢⱼ are replaced by σᵢ₊₄, 27 corresponding Tᵢⱼ, j=1, 2, . . . , 27 are obtained.

In a preferred embodiment, the first private key x and the second private key y are selected to be not less than 78 bits.

The shared secret key generated by the present disclosure is unsolvable by a third party. It serves as a core element in establishing a new and highly secure cryptosystem. The security and equivalence of unsolvable problem of the algorithm of the present disclosure can prove that it is immune to all attacks. In addition, since the secret key sharing method of the present disclosure uses unsolvable determination problem as a security guarantee, therefore the method is greatly secure both theoretically and in actual application aspect. Compared with the prior art, the present disclosure has the following advantages:

1. It is theoretically proved that all attacks to the secret key sharing algorithm of the present disclosure are not computable, and hence the secret key sharing algorithm of the present disclosure can resist all known attacks, including quantum computing attack.

2. Some private key selections are more secure due to the unsolvability of the Mihailova subgroup membership problem.

### DETAILED DESCRIPTION

The secret key sharing protocol of the present disclosure against quantum computing attack will be further described in detail below with reference to the embodiments.

### 1. Establish a Public Key Cryptographic Protocol Platform

Establish braid group Bₙ with exponent of n≥7, and two Mihailova subgroups A and B with unsolvable subgroup membership problem. In addition, due to the demand of cryptogram and secret key generation, Bₙ must further satisfy the following conditions:

1) The word that represents the element of Bₙ on the set of generators of Bₙ takes a computable normal form;

2) Bₙ is in exponential growth, i.e., the number of elements whose word length is a positive integer n, Bₙ is confined to an exponential function about n;

3) Multiplication and inversion of a group based on normal form is computable.

Therefore, the selected braid group Bₙ with exponent of n≥7 has the above characteristics, and the group Bₙ is defined by the following presentation:

Bₙ= [symbol] σ₁, σ₂, . . . , σₙ₋₁| σᵢσⱼ=σⱼσᵢ, |i−j|≥2, σᵢσᵢ₊₁σᵢ=σᵢ₊₁σᵢσᵢ₊₁, 1≤i≤n−2 [symbol] ,

each element of the braid group Bₙ being denoted by a word on a set {σ₁, σ₂, . . . , σₙ₋₁} that represents the element, possesses uniqueness and takes a normal form.

When n≥7, Bₙ contains two subgroups isomorphic to F₂×F₂, i.e., two subgroups isomorphic to the direct product of two free groups with a rank of 2:

P= [symbol] σ₁², σ₂², σ₄², σ₅²

[symbol]

and

[symbol]

= [symbol] σ₂², σ₃², σ₅², σ₆² [symbol] ;

then use a presentation that has a finite presentation group whose word problem is unsolvable and is generated by two elements so that subgroup A of P is a Mihailova subgroup, and subgroup B of [symbol] is a Mihailova subgroup;

56 generators of A are shown below, wherein i=1, and the 56 generators of A are obtained (if i=2, 56 generators of B are obtained):

σᵢ²σᵢ₊₃², σᵢ₊₁²σᵢ₊₄², Sᵢⱼ, Tᵢⱼ, j=1, 2, . . . , 27

while 27 Sᵢⱼ are:
Sᵢ₁: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₂: (σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²
Sᵢ₃: (σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²
Sᵢ₄: (σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁶)⁻¹ σᵢ₊₁⁻⁶σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²
Sᵢ₅: (σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁴)⁻¹ σᵢ₊₁⁻⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²
Sᵢ₆: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁴)¹ σᵢ₊₁⁻¹⁴σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₇: (σᵢ²σᵢ₊₁⁴σᵢ⁻²σᵢ₊₁⁴σᵢ⁴σᵢ₊₁⁻⁴σᵢ⁻²σᵢ₊₁⁻²σᵢ²σᵢ₊₁⁴(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁶σᵢ⁴σᵢ₊₁⁻¹⁰σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₈: (σᵢ²σᵢ₊₁⁶σᵢ⁻²σᵢ₊₁⁶σᵢ⁴σᵢ₊₁⁻⁶σᵢ⁻²σᵢ₊₁⁻²σᵢ²σᵢ₊₁⁶(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₉: (σᵢ²σᵢ₊₁⁸σᵢ⁻²σᵢ₊₁⁸σᵢ⁴σᵢ₊₁⁻⁸σᵢ⁻²σᵢ₊₁⁻²σᵢ²σᵢ₊₁²(σᵢ⁻⁴σᵢ₊₁⁻¹⁰σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,10}: (σᵢ²σᵢ₊₁¹⁰σᵢ⁻²σᵢ₊₁¹⁰σᵢ⁴σᵢ₊₁⁻¹⁰σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁⁶)⁻¹ σᵢ₊₁⁻⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,11}: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁶)⁻¹ σᵢ₊₁⁻¹⁶σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,12}: (σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁴)⁻¹ σᵢ₊₁⁻¹⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²
S_{i,13}: (σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²
S_{i,14}: (σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²
S_{i,15}: (σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²
S_{i,16}: (σᵢ₊₁⁻⁶σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻²⁰σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁⁶
S_{i,17}: (σᵢ₊₁⁻⁴σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²⁰σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁⁴
S_{i,18}: (σᵢ⁻⁴σᵢ₊₁⁻¹²σᵢ²σᵢ₊₁²σᵢ⁻²σᵢ₊₁¹²σᵢ⁴σᵢ₊₁⁻¹²σᵢ⁻²σᵢ₊₁⁻²σᵢ²σᵢ₊₁¹⁰σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁²σᵢ⁴ σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁²σᵢ⁴σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁⁻¹⁸σᵢ² σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁)²)² σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²)⁻¹ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)⁻²σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁⁻¹⁸σᵢ² σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ σᵢ⁻⁴σᵢ₊₁⁻¹²σᵢ²σᵢ₊₁²σᵢ⁻²σᵢ₊₁¹²σᵢ⁴σᵢ₊₁⁻¹²σᵢ⁻²σᵢ₊₁⁻²σᵢ²σᵢ₊₁¹⁰
S_{i,19}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶ σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,20}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)² σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)²σᵢ⁻⁴σᵢ₊₁¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,21}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)³ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)²σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)² σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)³σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,22}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁴ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)³σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)³ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁴σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,23}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁵ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁴ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁴ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁵σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,24}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁶ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁵ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁵ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁶σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,25}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁷ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁸σᵢ²σᵢ₊₁²94 ᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁶ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸)⁷σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,26}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁸ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁷ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁷ σᵢ⁻⁴σᵢ₊₁⁻⁶σᵢ²σᵢ₊₁²σᵢ⁻²σᵢ₊₁⁶σᵢ⁴σᵢ₊₁⁻⁶94 ᵢ⁻²σᵢ₊₁⁻²σᵢ²σᵢ₊₁⁶(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁸σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,27}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁸ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁸ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²

### 2. Establish Protocol of a Secret Key Sharing System

In the present embodiment, for example, the two parties of the protocol are Alice and Bob respectively.
(1) Alice and Bob select a braid group Bₙ with exponent n≥7, and the braid group Bₙ is defined by the following presentation:

Bₙ= [symbol] σ₁, σ₂, . . . , σₙ₋₁| σᵢσⱼ=σⱼσᵢ, |i−j|≥2, σᵢσᵢ₊₁σᵢ=σᵢ₊₁σᵢσᵢ₊₁, 1≤i≤n−2 [symbol] ,
each element of the braid group Bₙ being denoted by a word on a set {σ₁, σ₂, . . . , σₙ₋₁} that represents the element, possesses uniqueness and takes a normal form;
(2) Alice and Bob respectively select two sets of elements, a₁, a₂, . . . , aₖ∈A and b₁, b₂, . . . , bₘ∈B, of two Mihailova subgroups A and B in Bₙ respectively;
(3) Alice selects an element x=x (a₁, a₂, . . . , aₖ)∈A as a first private key, and sends x⁻¹b₁x, x⁻¹b₂x, . . . , x⁻¹bₘx to Bob;
(4) Bob selects an element y=y (b₁, b₂, . . . , bₘ)∈B as a second private key, and sends y⁻¹a₁y, y⁻¹a₂y, . . . , y⁻¹aₖy to Alice;
(5) Alice replaces all aᵢ in x with y⁻¹aᵢy (i=1, 2, . . . , k) to obtain

K_{A}=x⁻¹x(y⁻¹a₁y, y⁻¹a₂y, . . . , y⁻¹aₖy)=x⁻¹y⁻¹xy;
(6) Bob replaces all bⱼ in y with x⁻¹bⱼx (j=1, 2, . . . , m) to obtain

y⁻¹y(x⁻¹b₁x, x⁻¹b₂x, . . . , x⁻¹bₖx)=y⁻¹x⁻¹yx,
and calculates to obtain

K_{B}=(y⁻¹x⁻¹yx)⁻¹=x⁻¹y⁻¹xy;
since K_{A}=K_{B}, Alice and Bob reach a shared secret key K=K_{A}=K_{B}.

### Security Analysis:

First, the definitions of the two determination problems in the group are given.

Subgroup Membership Problem or Generalized Word Problem (GWP):

Given a subgroup H whose generator set is X in group G, determine whether any element g in G can be represented by a word on X, i.e., whether g is an element in H or not.

Conjugacy Search Problem (CSP):

Given that g and h are two elements in group G, and that there is an element c in G so that h=c⁻¹gc, determine whether there is element c′ in H so that h=c′⁻¹gc′.

In the secret key sharing protocol, attacker Eve can obtain the following information through public information and interactive process of Alice and Bob: braid group Bₙ with exponent n≥7, two sets of generated elements a₁, a₂, . . . , aₖ∈A and b₁, b₂, . . . , bₘ∈B of two Mihailova subgroups A and B of Bₙ, and elements x⁻¹b₁x, x⁻¹b₂x, . . . , x⁻¹bₘx and y⁻¹a₁y, y⁻¹a₂y, . . . , y⁻¹aₖy in Bₙ.

Eve only knows the normal form of the words that represent these elements of x⁻¹b₂x, . . . , x⁻¹bₘx and y⁻¹a₁y, y⁻¹a₂y, . . . , y⁻¹aₖy. However, Eve does not know the corresponding decomposed expressions.

If Eve can get x′∈Bₙ and y′∈Bₙ by solving the CSP problem so that x′⁻¹bᵢx′=x⁻¹bᵢx and y′⁻¹aⱼy′=y⁻¹aⱼy, i=1, 2, . . . , m, j=1, 2, . . . , k, however, Eve cannot guarantee x′=x and y′=y. Assuming x′=cₐx, y′=c_{b}y, then obtain (cₐx)⁻¹bᵢcₐx=x⁻¹cₐ⁻¹bᵢ cₐx=x⁻¹bᵢx from x′⁻¹bᵢx′=x⁻¹bᵢx and y′⁻¹aⱼy′=y⁻¹aⱼy so that cₐ⁻¹bᵢcₐ=bᵢ. That is, cₐ and bᵢ can be exchanged, i=1, 2, . . . , m. Similarly, c_{b} and aⱼ can be exchanged, j=1, 2, . . . , k. In addition, Eve must require (cₐx)⁻¹(c_{b}y)⁻¹cₐxc_{b}y=x⁻¹cₐ⁻¹y⁻¹c_{b}⁻¹cₐxc_{b}y=x⁻¹y⁻¹cₐ⁻¹c_{b}⁻¹cₐc_{b}xy=x⁻¹y⁻¹xy=K, and then there must be c_{b}cₐ=cₐc_{b}. Therefore, only when x′∈A and y′∈B, then there are cₐ∈A and c_{b}∈B. Since cₐ is exchangeable with all bᵢ, cₐ centralizes subgroups B. So when c_{b}cₐ=cₐc_{b}, Eve can get the correct shared secret key K. That is, Eve must know that x′ and y′ she obtained by solving the CSP problem are the elements of subgroup A and the elements of subgroup B, respectively. Thus, she must solve the membership problem of the elements of Mihailova subgroup A of x′ and y′ and subgroup B. However, this problem is unsolvable. Therefore, the secret key sharing protocol is secure. Eve cannot carry out an attack even with quantum computing system.

### Choosing of a Parameter:

In a preferred embodiment, the braid group Bₙ has exponent n≥7. The first private key x and the second private key y of the protocol are selected to be not less than 78 bits.

The foregoing describes a method for establishing anti-attack public key cryptogram of the present disclosure to help to understand the present disclosure. However, the implementation manners of the present disclosure are not limited by the foregoing embodiments. Any variation, modification, replacement, combination, and simplification made without departing from the principle of the present disclosure shall be an equivalent replacement manner and fall within the scope of protection of the present disclosure.

1. A method of establishing an anti-attack public key cryptogram, comprising the following steps:
(1) two parties of a protocol select a braid group Bₙ with exponent n≥7, and the braid group Bₙ is defined by the following presentation:
Bₙ= [symbol] σ₁, σ₂, . . . , σₙ₋₁| σᵢσⱼ=σⱼσᵢ, |i−j|≥2, σᵢσᵢ₊₁σᵢ=σᵢ₊₁σᵢσᵢ₊₁, 1≤≤n−2 [symbol] ,
each element of the braid group Bₙ being denoted by a word on a set {σ₁, σ₂, . . . , σₙ₋₁} that represents the element, possesses uniqueness and takes a normal form;
(2) the two parties of the protocol select two sets of elements in Bₙ, a₁, a₂, . . . , aₖ and b₁, b₂, . . . bₘ, to generate two subgroups A and B of Bₙ respectively;
(3) a first party of the two parties selects an element x=x (a₁, a₂, . . . , aₖ)∈A as a first private key, and sends x⁻¹b₁x, x⁻¹b₂x, . . . , x⁻¹bₘx to a second party of the two parties;
(4) the second party selects an element y=y (b₁, b₂, . . . , bₘ)∈B as a second private key, and sends y⁻¹a₁y, y⁻¹a₂y, . . . , y⁻¹aₖy to the first party;
(5) after the first party receives the elements sent by the second party, the first party replaces all aᵢ in x with y⁻¹aᵢy (i=1, 2, . . . , k) to obtain
K_{A}=x⁻¹x(y⁻¹a₁y, y⁻¹a₂y, . . . , y⁻¹aₖy)=x⁻¹y⁻¹xy;
(6) after the second party receives the elements sent by the first party, the second party replaces all bⱼ in y with x⁻¹bⱼx (j=1, 2, . . . , m) to obtain
y⁻¹y(x⁻¹b₁x, x⁻¹b₂x, . . . , x⁻¹bₖx)=y⁻¹x⁻¹yx,
and calculates to obtain
K_{B}=(y⁻¹x⁻¹yx)⁻¹=x⁻¹y⁻¹xy;
since K_{A}=K_{B}, the first party of the protocol and the second party of the protocol reach a shared secret key K=K_{A}=K_{B}.

2. The method of establishing an anti-attack public key cryptogram as claimed in claim 1, wherein the braid group Bₙ is a Mihailova subgroup having an unsolvable subgroup membership, and both the subgroups A and B are Mihailova subgroups.

3. The method of establishing an anti-attack public key cryptogram as claimed in claim 1, wherein the braid group Bₙ is a group defined by the following presentation:
Bₙ= [symbol] σ₁, σ₂, . . . , σₙ₋₁| σᵢσⱼ=σⱼσᵢ, |i−j|≥2, σᵢσᵢ₊₁σᵢ=σᵢ₊₁σᵢσᵢ₊₁, 1≤i≤n−2 [symbol] ,
each element of the braid group Bₙ is denoted by a word on a set {σ₁, σ₂, . . . , σₙ₋₁} that represents the element, possesses uniqueness and takes a normal form;
when n≥7, Bₙ contains two subgroups isomorphic to F₂×F₂, i.e., two subgroups isomorphic to the direct product of two free groups with a rank of 2:
P= [symbol] σ₁², σ₂², σ₄², σ₅² [symbol]
and [symbol]
= [symbol] σ₂², σ₃², σ₅², σ₆² [symbol] ;
then use a presentation that has a finite presentation group whose word problem is unsolvable and is generated by two elements so that subgroup A of P is a Mihailova subgroup, and subgroup B of [symbol] is a Mihailova subgroup;
56 generators of A are shown below, wherein i=1, and the 56 generators of A are obtained; and if i=2, 56 generators of B are obtained:
σᵢ²σᵢ₊₃², σᵢ₊₁²σᵢ₊₄², Sᵢⱼ, Tᵢⱼ, j=1, 2, . . . , 27
while 27 Sᵢⱼ are:
Sᵢ₁: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₂: (σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻¹σᵢ²σᵢ₊₁²σᵢ⁻²σᵢ₊₁⁴σᵢ⁴σᵢ₊₁⁻⁴σᵢ⁻²σᵢ₊₁⁻²σᵢ²
Sᵢ₃: (σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²
Sᵢ₄: (σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁶)⁻¹ σᵢ₊₁⁻⁶σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²
Sᵢ₅: (σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁⁴)⁻¹ σᵢ₊₁⁻⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²
Sᵢ₆: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁴)⁻¹ σᵢ₊₁⁻¹⁴σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₇: (σᵢ²σᵢ₊₁⁴σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₈: (σᵢ²σᵢ₊₁⁶σᵢ⁻²σᵢ₊₁⁶σᵢ⁴σᵢ₊₁⁻⁶σᵢ⁻²σᵢ₊₁⁻²σᵢ²σᵢ₊₁⁶(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
Sᵢ₉: (σᵢ²σᵢ₊₁⁸σᵢ⁻²σᵢ₊₁⁸σᵢ⁴σᵢ₊₁⁻⁸σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,10}: (σᵢ²σᵢ₊₁¹⁰σᵢ⁻²σᵢ₊₁¹⁰σᵢ⁴σᵢ₊₁⁻¹⁶σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁⁶)⁻¹ σᵢ₊₁⁻⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,11}: (σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁶)⁻¹ σᵢ₊₁⁻¹⁶σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²
S_{i,12}: (σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁴)⁻¹ σᵢ₊₁⁻¹⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²
S_{i,13}: (σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹²)⁻¹ σᵢ₊₁⁻¹²σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²
S_{i,14}: (σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁰)⁻¹ σᵢ₊₁⁻¹⁰σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²
S_{i,15}: (σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁⁸)⁻¹ σᵢ₊₁⁻⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²
S_{i,16}: (σᵢ₊₁⁻⁶σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻²⁰σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁⁶
S_{i,17}: (σᵢ₊₁⁻⁴σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻²⁰σᵢ²σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁⁴
S_{i,18}: (σᵢ⁻⁴σᵢ₊₁⁻¹²σᵢ²σᵢ₊₁²σᵢ⁻²σᵢ₊₁¹²σᵢ⁴σᵢ₊₁⁻¹²σᵢ⁻²σᵢ₊₁⁻²σᵢ²σᵢ₊₁¹⁰σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁²σᵢ⁴ σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁²σᵢ⁴σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁⁻¹⁸σᵢ² σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁)²)² σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²)⁻¹ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)⁻²σᵢ₊₁⁻²σᵢ⁻²σᵢ₊₁²σᵢ²σᵢ₊₁²σᵢ⁻⁴σᵢ₊₁⁻²σᵢ²σᵢ₊₁⁻²σᵢ⁻²σᵢ₊₁⁻¹⁸σᵢ² σᵢ₊₁²σᵢ⁻²σᵢ₊₁²⁰σᵢ⁴σᵢ₊₁⁻²⁰σᵢ⁻²σᵢ₊₁⁻²σᵢ²σᵢ₊₁²⁰(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ σᵢ⁻⁴σᵢ₊₁⁻¹²σᵢ²σᵢ₊₁²σᵢ⁻²σᵢ₊₁¹²σᵢ⁴σᵢ₊₁⁻¹²σᵢ⁻²σᵢ₊₁⁻²σᵢ²σᵢ₊₁¹⁰
S_{i,19}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶ σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,20}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)² σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁² σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)²σᵢ⁻⁴σᵢ₊₁¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,21}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)³ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)²σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)² σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)³σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,22}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁴ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)³σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)³ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁴σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,23}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁵ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶ σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁴ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁴ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁵σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,24}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁶ σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁴σᵢ²σᵢ₊₁²σᵢ⁻²σᵢ₊₁⁴σᵢ⁴σᵢ₊₁⁻⁴σᵢ⁻²σᵢ₊₁⁻²σᵢ²σᵢ₊₁⁴(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁵ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁵ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁶σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,25}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁷ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁸σᵢ²σᵢ₊₁²94 ᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻²σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁶σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁶ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸ σᵢ⁻⁴σᵢ₊₁⁻⁶σᵢ²σᵢ₊₁²σᵢ⁻²σᵢ₊₁⁶σᵢ⁴σᵢ₊₁⁻⁶σᵢ⁻²σᵢ₊₁⁻²σᵢ²σᵢ₊₁⁶σᵢ⁻⁴σᵢ₊₁⁻¹⁰σᵢ²σᵢ₊₁²σᵢ⁻²σᵢ₊₁¹⁰σᵢ⁴σᵢ₊₁⁻¹⁰σᵢ⁻¹σᵢ₊₁⁻²σᵢ²σᵢ₊₁¹⁰ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁷σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,26}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁸ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁷ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁷ σᵢ⁻⁴σᵢ₊₁⁻⁶σᵢ²σᵢ₊₁²σᵢ⁻²σᵢ₊₁⁶σᵢ⁴σᵢ₊₁⁻⁶94 ᵢ⁻²σᵢ₊₁⁻²σᵢ²σᵢ₊₁⁶(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁸σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
S_{i,27}: (σᵢ₊₁⁻⁴σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁¹⁸(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁹ (σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³(σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁸ σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²)⁻¹ σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴(σᵢ⁻⁴σᵢ₊₁⁻¹⁴σᵢ²σᵢ₊₁²σᵢ⁻²σᵢ₊₁¹⁴σᵢ⁴σᵢ₊₁⁻¹⁴σᵢ⁻²σᵢ₊₁⁻²σᵢ²σᵢ₊₁¹⁴)⁸ σᵢ⁻⁴σᵢ₊₁⁻⁸σᵢ²σᵢ₊₁²σᵢ⁻²σᵢ₊₁⁸σᵢ⁴σᵢ₊₁⁻⁸σᵢ⁻²σᵢ₊₁⁻²σᵢ²σᵢ₊₁⁸(σᵢ⁻⁴σᵢ₊₁⁻²σᵢ²σᵢ₊₁²σᵢ⁻²σᵢ₊₁²σᵢ⁴σᵢ₊₁⁻²σᵢ⁻²σᵢ₊₁⁻²σᵢ²σᵢ₊₁²)³ (σᵢ⁻⁴σᵢ₊₁⁻¹⁶σᵢ²σᵢ₊₁²σᵢ⁻²σᵢ₊₁¹⁶σᵢ⁴σᵢ₊₁⁻¹⁶σᵢ⁻²σᵢ₊₁⁻²σᵢ²σᵢ₊₁¹⁶)⁹σᵢ⁻⁴σᵢ₊₁⁻¹⁸σᵢ²σᵢ₊₁²σᵢ⁻²σᵢ₊₁¹⁸σᵢ⁴σᵢ₊₁⁻¹⁸σᵢ⁻²σᵢ₊₁⁻²σᵢ²σᵢ₊₁²
when all σᵢ in each Sᵢⱼ are replaced by σᵢ₊₃ and all σᵢ₊₁ in each Sᵢⱼ are replaced by σᵢ₊₄, 27 corresponding Tᵢⱼ, j=1, 2, . . . , 27 are obtained.

4. The method of establishing an anti-attack public key cryptogram as claimed in claim 1, wherein the first private key x and the second private key y are selected to be not less than 78 bits.
